(19) United States
(12) Patent Application Publication
(10) Pub. No.: US 2024/0006906 A1
(43) Pub. Date: Jan. 4, 2024

(54) MULTI-PORT CHARGING STAND

(71) Applicant: WAHL CLIPPER CORPORATION, Sterling, IL (US)

(72) Inventor: David Joseph TODD, Polo, IL (US)

(21) Appl. No.: 17/810,070

(22) Filed: Jun. 30, 2022

(51) Int. Cl. H02J 7/00; H02M 3/156; H02M 3/06

(52) U.S. Cl. CPC H02J 7/00716; H02J 7/0044; H02J 7/0018; H02M 3/156; H02M 3/06

(57) ABSTRACT

A battery charger has at least one charging port for a device having a rechargeable battery, and a charging circuit. The charging circuit includes a DC-DC circuit, a current regulation circuit (CRC) and an output voltage adjustment circuit (OVA), the charging port being electrically connected to an output of the CRC. The OVA reduces the power consumed by the CRC circuit by depressing a voltage at the input of the CRC so that the CRC output voltage is sufficient to charge the rechargeable battery when it is discharged. The OVA circuit increases the input voltage of the CRC as the rechargeable battery is charged.

This invention relates to battery chargers, and more particularly, to battery chargers for multiple hair clippers and other devices.

### BACKGROUND OF THE INVENTION

Many personal care devices such as hair clippers, beard trimmers and the like, as well as phones, have rechargeable batteries. Some such devices require a dedicated charger port, and others only need a USB or other generic port. If each device has an individual charger plugged into a line voltage receptacle, though, the number of devices and cords becomes unsightly and unmanageable.

For this reason, chargers that accommodate more than one device are now available. However, as the number of charging ports increases, the overall size of the charger increases, which is not desirable. Power consumption, which generates heat, also increases if multiple batteries are charged at the same time. Thus, there is a need for battery chargers with multiple charging ports and compact size. There is also a need for battery chargers that control heat dissipation.

Accordingly, one object of this invention is to provide new and improved battery charging devices.

Another object is to provide new and improved battery chargers for multiple hair clippers and other devices.

Yet another object is to provide new and improved battery chargers with multiple charging ports and compact size.

### SUMMARY OF THE INVENTION

A battery charger has at least one charging port for a device having a rechargeable battery, and a charging circuit. The charging circuit includes a DC-DC circuit, a current regulation circuit (CRC) and an output voltage adjustment circuit (OVA), the charging port being electrically connected to an output of the CRC. The OVA reduces the power consumed by the CRC circuit by depressing a voltage at the input of the CRC so that the CRC output voltage is sufficient to charge the rechargeable battery when it is discharged. The OVA circuit increases the input voltage of the CRC as the rechargeable battery is charged.

### BRIEF DESCRIPTION OF THE DRAWINGS

The above mentioned and other features of this invention and the manner of obtaining them will become more apparent, and the invention itself will be best understood by reference to the following description of an embodiment of the invention taken in conjunction with the accompanying drawings, in which:

FIG. 1 is a perspective view of one embodiment of a charging stand according to the present invention;

FIG. 2 is a perspective view of the charging stand of FIG. 1, with rechargeable battery devices in the charger;

FIG. 3 is a block schematic diagram of output adjustment circuitry in the charging stand of FIG. 1;

FIG. 4 is a detailed circuit diagram of a portion of the output adjustment circuitry of the charging stand of FIG. 1;

FIG. 5 is a graph of simulation results illustrating the operation of the output adjustment circuit of FIG. 3;

FIG. 6 is a graph comparing power dissipation with and without the output adjustment circuit of FIG. 1;

FIG. 7 is a graph showing the operation of a battery charger with the Output voltage adjustment circuit of the present invention, and

FIG. 8 is a graph showing the operation of a battery charger without an output voltage adjustment circuit.

### DETAILED DESCRIPTION

Small size can be maintained in a battery charger for multiple devices by controlling the power needed to charge all of the devices simultaneously. Power can be controlled by regulating the current regulating portion of the charger. In order to reduce the wattage (heat) dissipated by the current regulating portion of the circuit, either the voltage must be dropped or the current through the circuit needs to be reduced. As current directly affects charge time, it is not desirable to reduce current. Voltage can be reduced, but some devices need to sense a certain voltage to properly detect a full charge. When a full charge is detected, the device effectively cuts the battery off from the charger so that the battery is not overcharged.

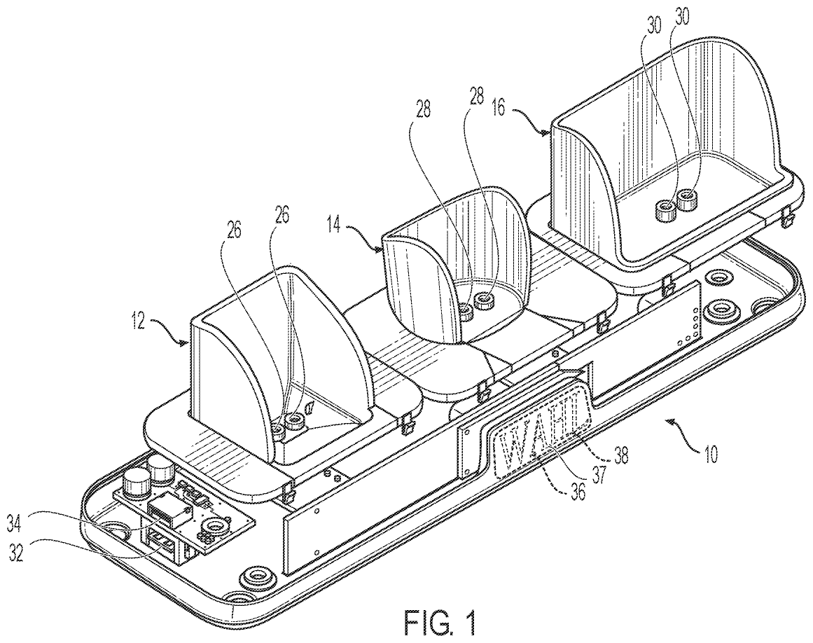

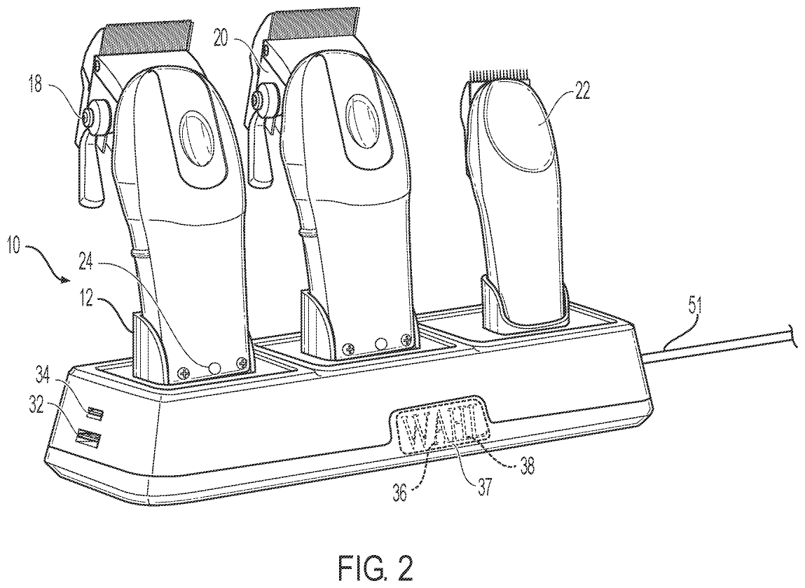

As seen in FIGS. 1 and 2, a charging stand 10 has sockets 12, 14 and 16 for battery powered hair clippers/trimmer devices 18, 20 and 22. The devices 18, 20 and 22 each have an LED 24 that is illuminated when internal batteries (not shown) in the devices 18, 20 and 22 are fully charged. The devices also have pins (also not shown) for electrically connecting the batteries in the devices 18, 20 and 22 to pogo pins 26, 28, 30 in the stand 10, for battery charging purposes. While the pogo pins are a form of a port, a port could be hard wired, as well.

The stand 10 has a pair of USB ports 32, 34 for cell phones and the like. The stand 10 also has an LED 36 that informs a user that charging is enabled by emitting blue light, and an LED 38 that informs the user that charging is disabled by emitting red light. A semi-transparent cover 37 includes a company logo that is featured when the LED 36 or the LED 38 is turned on.

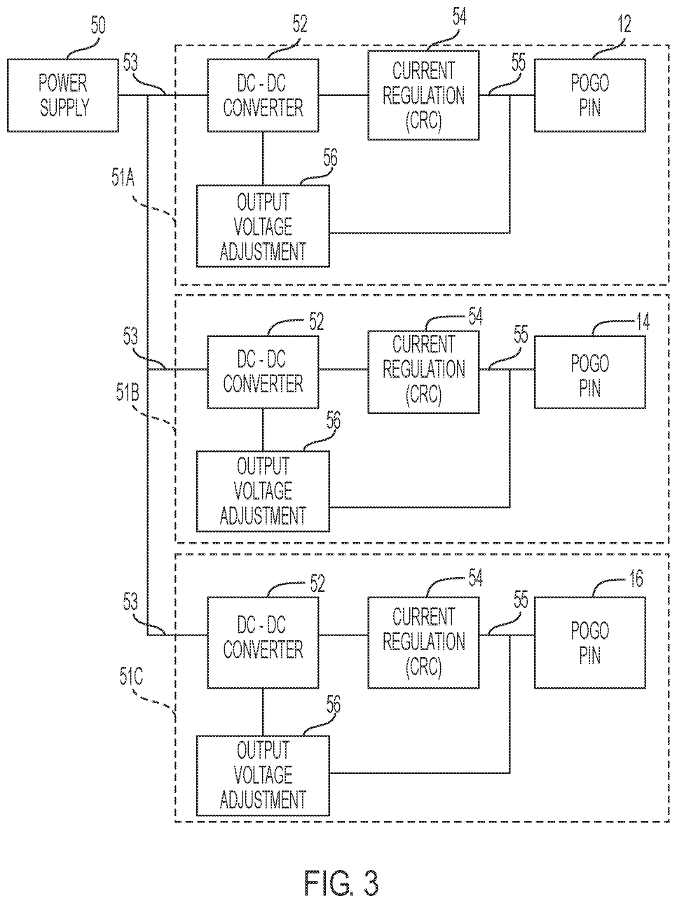

A block diagram of the charging circuitry is seen in FIG. 3. The circuitry in FIG. 3 accommodates the three devices shown in FIG. 2 with three power adjustment circuits (PACs) 51a, 51b and 51c. The PACs 51a, 51b and 51c are identical, except that the PAC 51a feeds power to the pogo pins 12, the PAC 51b feeds power to the pogo pins 14, and the PAC 51c feeds power to the pogo pins 16.

In FIG. 3, an AC-DC converter 50 or other suitable power supply presents a DC voltage to a DC-DC converter 52 through a line 53. The DC voltage from the AC-DC converter 50 could come through a USB-C or other suitable connector. The output of the DC-DC converter 52 is passed to a current regulation circuit (CRC) 54. An output 55 of the CRC 54 of the PAC 51a is passed to the charging pins 12, the output 55 of the PAC 51b is passed to the pins 14, and the output 55 of the PAC 51c is passed to the pins 16.

An output voltage adjustment circuit (OVA) 56 monitors the voltage of the output 55 of the CRC 54, and reduces the output voltage of DC-DC converter 52 to avoid overloading in the event that the connected battery has a low charge. As the connected battery charges, the output voltage is returned to a higher level, as will be seen. The voltage is returned to a higher level so that a sensing circuit in the device being charged is triggered to indicate through LED 24 that charge is complete.

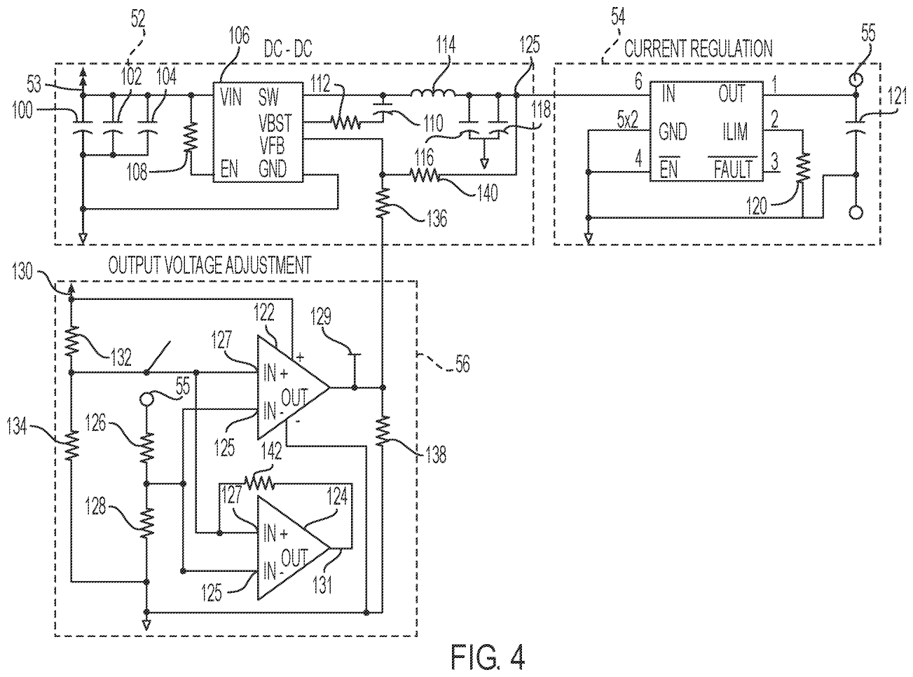

The circuitry in FIG. 3 is shown in greater detail in FIG. 4. The DC-DC converter 52 includes capacitors 100,102 and 104 connected between the voltage input line 53 and ground. The input line 53 is connected to a Vin pin on a DC-DC regulator 106, such as an AP62200WU-7. The input line 53 is also connected to a resistor 108, which in turn is connected to a pin EN. A switched output SW of the regulator 106 is fed to a capacitor 110 and series resistor 112 to a pin VBST, and one end of a series inductor 114. The other end of the inductor 114 is connected to parallel capacitors 116 and 118, which in turn are connected to ground, and to input pin IN of the CRC 54.

The CRC 54 is a suitable IC, such as a AP22652FDZ-7, having an input terminal IN connected to the output of the DC-DC Converter 52, an output terminal OUT connected to the output 55, a resistor 120 connected between the terminal ILIM and ground, and a capacitor 121 connected between the output 55 and ground.

The OVA 56 has two comparators 122 and 124. The output 55 is fed to inverting In− terminals 125 of comparators 122 and 124 through a voltage divider made up of resistors 126 and 128. A fixed voltage from a power source line 130 is fed to non-inverting In+ terminals 127 of the comparators 122 and 124 through another voltage divider made up of resistors 132 and 134.

The output voltage 129 is divided by resistors 136,138, 140, and is fed to a feedback pin VFB in the regulator 106. The resistor 140 is connected to the output 125 of the DC-DC converter 52.

The output pin 131 of the comparator 124 is connected to the non-inverting input In+ terminals 127 of comparators 122 and 124 through a resistor 142.

In operation, each output voltage adjustment circuit 56 of PACs 51a, 51b, 51c monitors the voltage at respective outputs of the CRC 54 through voltage divider 126/128 connected to the inverting inputs 125 of comparators 122 and 124. The non-inverting inputs 127 are connected to a reference voltage through voltage divider 132/134. The comparators 122, 124 both have open-drain outputs, so the outputs will either be in a high impedance (Hi-Z) state or shorted to ground. When the voltage at the inverting input 125 is less than the voltage at the non-inverting input 127, the outputs are in the Hi-Z state. When the opposite is true, the outputs are shorted to ground.

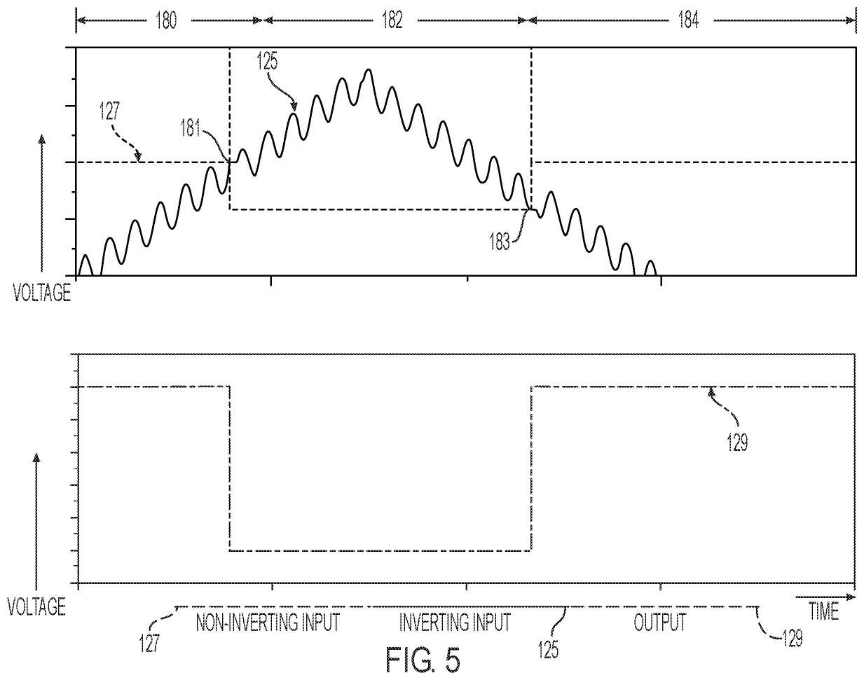

FIG. 5 shows the voltage levels of the non-inverting inputs 127, the inverting inputs 125, and the outputs 129 as the inputs change over time. The inverting inputs 125 are indicative of the voltage at the output 55. When the output of the comparator 124 is in the Hi-Z state, the resistor 142 is floating and does not affect the circuit, so the voltage to the non-inverting inputs is at a steady level, as shown in the dashed line 127 (non-inverting inputs) in the left-most portion 180 of FIG. 5.

When the voltage at output 55 (inverting input 125) rises to the point 181 in FIG. 5, the output 131 of the comparator 124 is shorted to ground, bringing the resistor 142 into parallel with the resistor 134, and the total resistance decreases. This in turn decreases the voltage at the non-inverting inputs 127, creating a second input voltage 127 level in a region 182 in FIG. 5. These two voltage levels prevent the voltage ripple inherent in the DC-DC converter output from causing the comparator outputs to oscillate. This ripple can be seen on the inverting input curve 125 of FIG. 5.

When the output 129 of the comparator 122 is in the Hi-Z state, the effective total resistance of the voltage divider 136/138/140 increases because the resistor 138 is in series with the resistor 136. When the output of the comparator 122 is shorted to ground, the resistor 138 is eliminated from the circuit, which reduces the total resistance for the voltage divider 136/138/140. This change in resistance changes the voltage seen at the VFB pin of the DC-DC converter 52 which in turn returns the output voltage 129 from the DC-DC converter 52 that feeds into the CRC 54 to a high state, in portion 184 of FIG. 5. The device being charged recognizes that its battery is fully charged, and indicates such through LED 24.

The two separate comparators prevent the 132/134/142 voltage divider from affecting the 136/138/140 voltage divider, as they are supplied from different sources and provide different functionality. The inputs are connected in parallel though so both comparators 122,124 transition together.

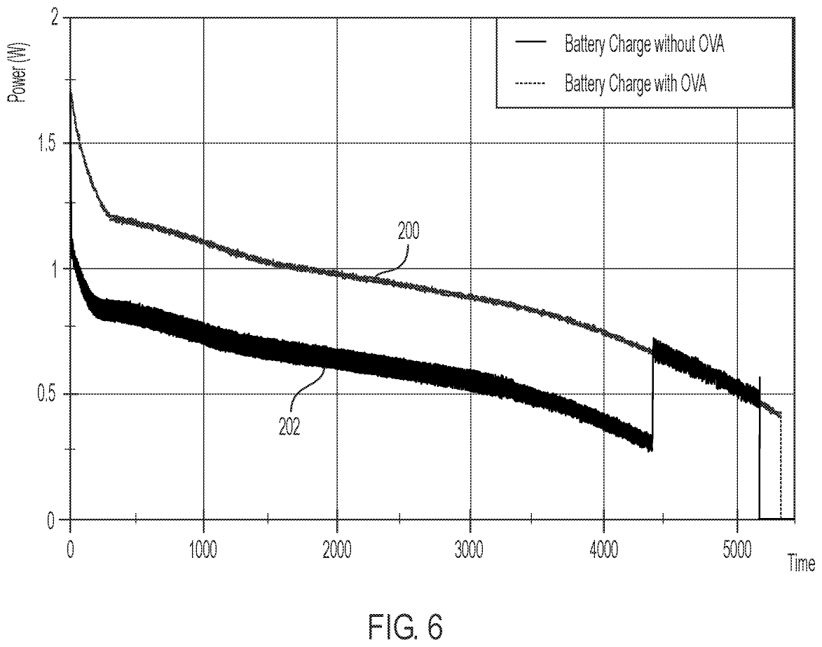

FIG. 6 shows a comparison between the power dissipated by the CRC 54 without the OVA 56 in line 200, and the power dissipated by the CRC 54 with the OVA 56 in line 202 during a battery charge. The power dissipated by the CRC 54 is defined as P=(Vin−Vout)*I. When the CRC 54 is charging a completely discharged connected battery, as at the left side of the lines 200 and 202 (time=0), the output 55 of the CRC 54 will start at the minimum battery voltage and increase over time as the battery charges until it reaches the battery maximum voltage. When the battery reaches its maximum voltage, circuitry internal to the device being charged will electrically isolate the battery from the charger to prevent further charging of the battery. Since the circuitry draws much less current than the battery being charged, the voltage output of the CRC 54 will increase to a higher level. This increase, along with other measurements, can be used by the device to detect when the unit is finished charging.

Throughout the charge, the circuit maintains a constant current level. This, in combination with a fixed DC-DC output voltage of a high enough level that the unit being charged can detect an increased voltage at the end of the charge, can lead to excessive power dissipation by the CRC in the form of heat. This heat, if left unchecked, can damage components, or if the components have over temperature protections, can cause them to interrupt the charge. To overcome this excessive power dissipation, the OVA 56 lowers the DC-DC output voltage during the initial portion of the charge when the battery voltage is low, and the CRC 54 power dissipation would otherwise be the highest. Once the battery reaches a higher voltage, the CRC 54 increases the output voltage of the DC-DC converter 52 to the level necessary for the unit being charged to detect end of charge. As the battery voltage is higher when this transition happens, there is less power dissipated by the CRC 54 than when the charge initially started. This results in an overall lower power dissipation of the CRC and therefore less heat generation, as seen in FIG. 6.

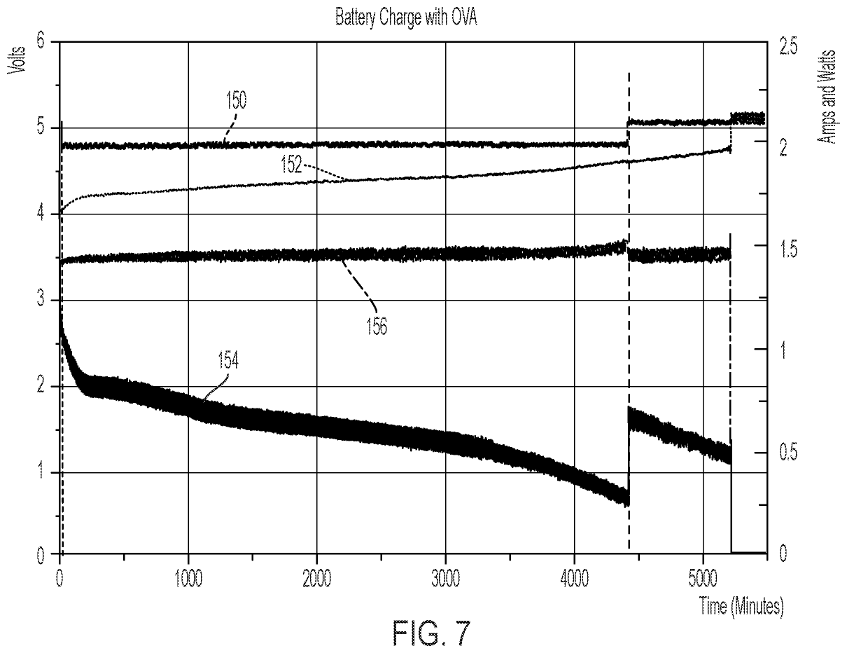

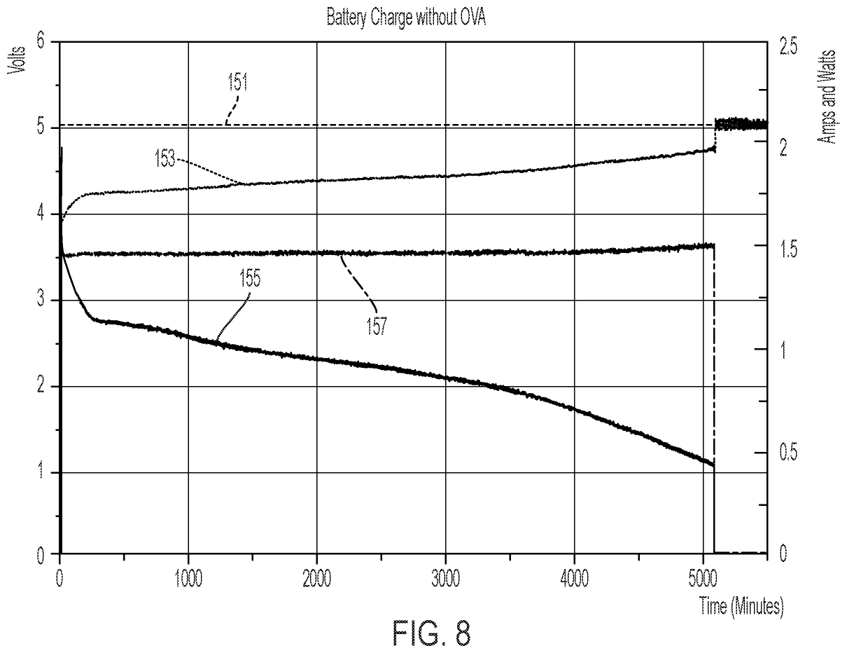

The OVA 56 provides voltage control of the charger. FIGS. 7 and 8 compare the operating results of a battery charger with and without the OVA 56. The left ordinates measure voltage, the right ordinates measure current/wattage, and the abscissas measures time. FIGS. 7 and 8 show the output currents 156,157 respectively at the CRC output 55, the output voltages 152, 153 at the CRC output 55, the voltage outputs 150, 151 at the output 125 of the DC-DC Converter 52 and the CRC power dissipation 154,155.

The nominal voltage of a charged lithium ion battery is about 3.6 volts. The voltage decreases as the battery discharges, and increases as the battery is charged. For this purpose, assume that the voltage at the CRC output 55 is close to, but greater than, the voltage of the battery being charged. Power consumption of the charger, which generates heat, is a measure of the output voltage 154 at the DC-DC converter output 125 minus the CRC output voltage 152 times the CRC output current 156 (P=(Vin−Vout)*Iout).

The battery charger measured in FIG. 7 included the OVA 56, and the charger in FIG. 8 did not have the OVA 56. When the voltage of the rechargeable battery was low (time is 0-500 seconds) in FIG. 7, the voltage 152 was about 4 volts, and the current 156 was about 1.5 amps. When the voltage of the rechargeable battery increased, the output voltage 55 of the CRC increased until the rechargeable battery was fully charged.

Power consumption was measured as the DC-DC output 125 minus the CRC output voltage 55 (line 152) times the CRC output current 156 (P=(Vin−Vout)*Iout). The result is line 154, which is about 0.8 watts at about 250 minutes, about 0.6 watts after about 2000 minutes, and about 0.4 watts at about 4000 minutes. The jump in the watts in line 154 at about 4500 minutes indicates when the outputs 129,131 of comparators 122,124 have transitioned to a short to ground to increase the DC-DC output 125 as seen in line 150. The jump in volts in line 152 after about 5250 minutes indicates that the device detected that the battery has reached the maximum charge voltage and the battery can be electrically isolated from the charging circuitry and the LED 24 can be illuminated to indicate the charge is complete.

As seen in FIG. 8, a charger without the OVA 56 drew more power. Power consumption was measured at the DC-DC output 125 (155 in FIG. 8) minus the CRC output voltage 55 (line 153 in FIG. 8) times the CRC output current 157 (P=(Vin−Vout)*Iout). Line 155 was about 1.25 watts at about 250 minutes, about 0.8 watts after about 2000 minutes, and about 0.7 watts at about 4000 minutes. Thus, the power consumed with the OVA 56 was reduced by about 0.45 watts at 250 minutes, 0.2 watts at 2000 minutes, and 0.3 watts at 4000 minutes.

Advantages of the invention are now apparent. Several rechargeable batteries can be charged by a compact charger. Heat is reduced while charging, and deficiency is improved.

While the principles of the invention have been described above in connection with specific apparatus and applications, it is to be understood that this description is made only by way of example and not as a limitation on the scope of the invention.

What is claimed is:

1. A battery charger comprising at least one charging port for a device having a rechargeable battery and a charging circuit,
the charging circuit having a DC-DC circuit, a current regulation circuit (CRC) and an output voltage adjustment circuit (OVA), the charging port being electrically connected to an output of the CRC,
wherein the OVA reduces the power consumed by the CRC circuit by depressing a voltage at the input of the CRC so that the CRC output voltage is sufficient to charge the rechargeable battery when it is discharged, the OVA circuit increasing the input voltage of the CRC as the rechargeable battery is charged.

2. The battery charger of claim 1 comprising a plurality of charging ports for a plurality of devices, and a charging circuit for each charging port.

3. The battery charger of claim 1 wherein the OVA includes first and second open drain comparators, each of the comparators having a non-inverting input In+, an inverting input In− and an output,
wherein further the output of the CRC is fed to the inverting In-terminals of the first and second comparators through a first voltage divider,
a fixed voltage from a power source is fed to the non-inverting In+ terminals of the first and second comparators through a second voltage divider, and
the output of the first comparator is connected to a first resistor and a second resistor, the first resistor also being connected to ground and the second resistor also being connected to a feedback pin in the DC-DC converter,
a third resistor being connected between the feedback pin of the CRC and the output of the CRC.
